(19) United States
(12) Patent Application Publication
(10) Pub. No.: US 2012/0215747 A1
(43) Pub. Date: Aug. 23, 2012

(54) DATA UPLOADING METHOD, DATA DOWNLOADING METHOD, AND DATA SYSTEM

(75) Inventor: Tieying WANG, Hangzhou (CN)

(73) Assignee: HUAWEI TECHNOLOGIES CO., LTD.

(21) Appl. No.: 13/458,258

(22) Filed: Apr. 27, 2012

Related U.S. Application Data
(63) Continuation of application No. PCT/CN2011/073461, filed on Apr. 28, 2011.

(30) Foreign Application Priority Data
Apr. 28, 2010 (CN) 201010159941.1

(51) Int. Cl. G06F 15/167; G06F 17/30; G06F 7/00

(52) U.S. Cl. 707/690; 709/216; 707/769; 707/E17.005; 707/E17.014

(57) ABSTRACT

The present invention provides a data uploading method, a data downloading method, and a data system. The uploading method includes: receiving a data uploading request of a user and obtaining a content ID of data to be uploaded; determining, according to the content ID, whether the data to be uploaded is already stored; and if the data to be uploaded is not stored, uploading the data to be uploaded to a local data center and storing the data to be uploaded. According to the embodiments of the present invention, a data traffic load between different networks is reduced and response efficiency is increased; uniform management and quick query of content copies in different networks are realized, and the number of distribution of copies of the same content in the network in the system is reduced.

### CROSS-REFERENCE TO RELATED APPLICATIONS

This application is a continuation of International Application No. PCT/CN2011/073461, filed on Apr. 28, 2011, which claims priority to Chinese Patent Application No. 201010159941.1, filed on Apr. 28, 2010, both of which are hereby incorporated by reference in their entireties.

### FIELD OF THE INVENTION

The present invention relates to the field of communication technologies, and in particular, to a data uploading method, a data downloading method, and a data system.

### BACKGROUND OF THE INVENTION

With the popularity of intelligent access terminals and the diversification of access modes, large quantities of user generated contents (UGC, User Generated Content) are produced, which are stored, shared, and distributed in a network. In order to guarantee user experience, enough network resources and especially, large-scale storage resources in the network, are needed for support. The diversification of services constructed on these resources drives the setup of many data centers, and these data centers logically form a huge resource pool. In the resource pool, same contents are used repeatedly by many services, but resources are allocated for copies of the contents according to respective services. In the prior arts, high-speed networks like private networks are needed to ensure processing of data services, or a multi-network environment is needed to ensure content synchronization, thus increasing the maintenance and operation cost of the system and reducing the utilization of the resource pool.

Currently, commonly-used solutions include the following. A directional server technology is adopted, where a message sent to another network is first sent to a transfer server in a local network, and inter-network message interaction is performed through the transfer server between networks. This may satisfy processing of some messages, but there is a bottleneck for large quantities of data service requests, and high-speed networks like private networks are needed for assurance. An image server technology is adopted, where each network implements content synchronization with other networks. Content changes in any network are all imaged to data centers of other networks. This ensures consistency in a multi-network environment, but inter-network traffic is large, which results in a waste of traffic; inter-network copies are highly dynamic so that synchronization is difficult in short time.

### SUMMARY OF THE INVENTION

Purposes of the present invention are to provide a data uploading method, a data downloading method, and a data system, which simplify a system and increase utilization of resources.

One embodiment of the present invention provides a data uploading method, including the following steps: receiving a data uploading request of a user, and obtaining a content ID; determining, according to the content ID, whether the content already exists; and if the data to be uploaded is not stored, uploading the data to be uploaded to a local data center and storing the data to be uploaded.

Another embodiment of the present invention provides a data downloading method, including the following steps: receiving a data downloading request of a user, and obtaining a content ID; determining, according to the content ID, whether the data is stored in a local data center or a non-local data center; if the data is stored in a non-local data center, obtaining the data from the non-local data center and storing the data in the local data center; and downloading the data from the local data center.

Another embodiment of the present invention provides a data system, including:

an edge server, configured to: receive a data uploading or downloading request of a user and obtain a content ID; determine, according to a query result of a media manager, whether to store the data and obtain information of a data center that stores the data; determine, according to the information of the data center, whether the data is stored in a local data center or a non-local data center and, if the data is stored in a non-local data center, request the non-local data center to check the data to be uploaded or downloaded;

multiple data centers, configured to query, according to the content ID, an address of a corresponding node that stores the data;

the media manager (MM, Media Manager), configured to query, according to the content ID of the data, the information of the data center that stores the data, and return the query result to the edge server; and

a multilateral gateway, configured to exchange information between the multiple data centers.

The embodiments of the present invention are implemented through a two-line or multi-line gateway, and high-speed networks like private networks are not needed, thus saving the cost, reducing a data traffic load between different networks and increasing response efficiency, and increasing utilization of a resource pool.

### BRIEF DESCRIPTION OF THE DRAWINGS

Accompanying drawings to be described here are used to provide further understanding of the present invention, and constitute part of the present invention, but do not limit the present invention. In the accompanying drawings:

FIG. 1 is a flowchart of a data uploading method according to a first embodiment of the present invention;

FIG. 2 is a flowchart of a data uploading method according to a second embodiment of the present invention;

FIG. 3 is a flowchart of a data downloading method according to a third embodiment of the present invention;

FIG. 4 is a schematic structural diagram of a data system according to a fourth embodiment of the present invention; and

FIG. 5 is a schematic structural diagram of a data center according to the fourth embodiment of the present invention.

### DETAILED DESCRIPTION OF THE EMBODIMENTS

To make the purposes, technical solutions, and benefits of the embodiments of the present invention more clearly, the embodiments of the present invention are further described in detail below with reference to the embodiments and the accompanying drawings. The exemplary embodiments of the present invention and the description are used to explain the present invention, and are not intended to limit the present invention.

### Embodiment 1

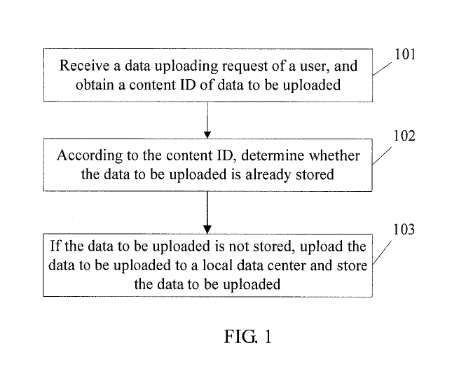

This embodiment provides a data uploading method. As shown in FIG. 1, the method includes:

Step 101: Receive a data uploading request of a user, and obtain a content ID of data to be uploaded.

This step may be executed by an edge server (ES, Edge Server) in a distributed data storage system. An ES node stores domain information of a domain where the ES node is located, namely, a data center address (NetID) of the domain where the ES node is located. The ES only communicates with a storage node (CS, Chunk Server) in the data center of the domain where the ES node is located. After the ES receives the data uploading request or triggers processing of data uploading, the ES obtains the content ID (OID, Object ID) of the data to be uploaded through a Hash algorithm, and cascades the NetID of the domain where the ES is located after the OID, for example, “01982736AFED01982736AFED01982736 1”, where the first 32 characters (128 bits) are the OID obtained through the Hash algorithm applied to the data to be uploaded, and the last one character represents the NetID1 of the data center of the domain where the ES is located.

Step 102: According to the content ID, query whether the data to be uploaded is already stored.

This step may be executed by the ES and MM of the distributed data storage system. The MM stores a content ID of data uploaded successfully and a NetID2 (data center information) of a data center that stores the data. After the ES receives the data uploading request of the user, the ES submits a query request to the MM, where the query request carries the content ID of the data and the NetID1 of the data center where the ES is located. The MM queries whether a matched content ID is stored, and sends a query result to the ES. The query request submitted by the ES may be an authentication request which requests to authenticate whether the user has the right to upload information. If the MM authenticates that the use has the right to upload information, the MM further queries whether a matched content ID is stored, and carries corresponding user information, such as username, password, and IP address, in an authentication success response. If the MM authenticates that the user does not have the right to upload information, the ES ends the uploading upon receiving an authentication failure response.

Step 103: If the data to be uploaded is not stored, upload the data to be uploaded to a local data center and store the data to be uploaded.

This step may be executed by the ES. If the data to be uploaded is not stored, the ES uploads the data to the data center where the ES is located (that is, the local data center) and stores the data. Specifically, the ES sends an uploading request to an access storage node (ACS, Access CS) of the local data center, the ACS queries an index node (ICS, Index CS) of the local data center whether an address of a CS corresponding to the content ID is registered; if the address is registered, the ES continues uploading the data to the CS from a breakpoint and stores the data. If the address is not registered, the ES uploads the data to the ACS and stores the data. After the data is completely stored, the CS/ACS storing the data registers the OID of the data and the address of the CS/ACS itself with the ICS. After the uploading is successful, the ES registers the OID of the data to be uploaded and the cascaded NetID of the data center that stores the data (that is, the NetID of the data center where the ES is located) with the MM.

In this embodiment, if the MM queries and finds that the matched content ID is stored, a query response returned to the ES carries the NetID2 of the data center that stores the data. A consistency check of the data center is performed according to the information of the data center that stores the content, and after the check is successful, an upload success response is fed back to the user. The ES compares the received NetID2 of the data center that stores the data and the NetID1 of the data center where the ES is located. If they are consistent, the data is stored in the data center where the ES is located, and the ES obtains the CS address corresponding to the ID of the data to be uploaded, namely, the address of the node that stores the data, from the index node of the local data center. The ES obtains check information from the node that stores the data. If the check information is consistent with the data to be uploaded, it indicates that the data is stored, and the ES feeds back an upload success response to the user, or else the ES ends the uploading. If the NetID1 and the NetID2 are inconsistent, the data is not stored in the data center where the ES is located, and the ES requests check information from the CS of the data center that stores the data through a gateway (GW, Gateway) with a heavy binding weight with the ES. If the check information is consistent with the data to be uploaded, it indicates that the data is stored, and the ES feeds back an upload success response to the user, or else ends the uploading. The check information may be offset block information or other commonly-used check information.

In the embodiment of the present invention, whether the data is stored is judged according to the content ID of the data, so as to reduce the number of distribution of copies of the same content in the network in the system; when an upload network and a storage network are different, information interaction is performed through a bilateral or multilateral gateway, thus reducing a data traffic load between networks and increasing response efficiency.

### Embodiment 2

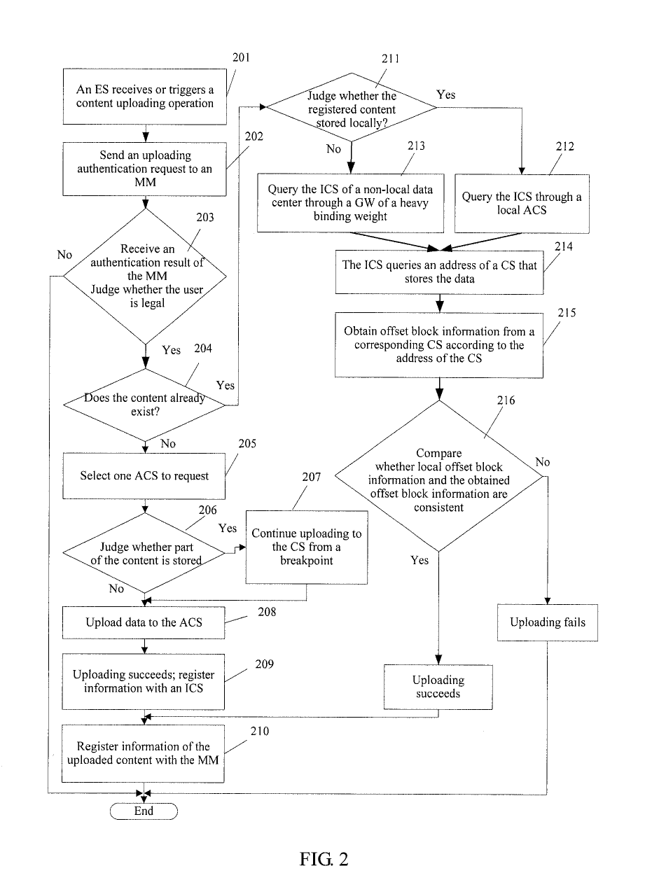

This embodiment provides a data uploading method. As shown in FIG. 2, the method includes:

Step 201: An ES receives a data uploading request or triggers processing of data uploading, and obtains a content ID (OID) of the data. The ES obtains a temporary OID of the data and cascades a NetID1 of a domain where the ES is located with the temporary OID, for example, “01982736AFED01982736AFED01982736 1”, where the first 32 characters (128 bits) are the OID obtained through a Hash algorithm applied to the data to be uploaded, and the last one character represents the NetID1 of the data center where the ES is located.

Step 202: The ES submits, to an MM, a request for authenticating legality of the uploading of the user. The ES sends related information of the user and the OID and the NetID1 to the MM. The MM authenticates, according to the related information of the user, whether the user has the upload right. If the uploading is legal, the MM further queries, according to the OID, whether the data to be uploaded is registered, and returns an authentication and registration result to the ES through a response. When the registration result is a NetID2 of a data center that stores the data to be uploaded, it indicates that the data to be uploaded is registered, and otherwise, the data is not registered.

Step 203: The ES receives the response returned by the MM, and judges whether the user is legal. If the authentication result in the response is that the user is illegal, the ES ends the uploading; if the authentication result in the response is that the user is legal, proceed to step 204.

Step 204: The ES judges whether the data to be uploaded is stored. If the data to be uploaded is not registered, proceed to step 205; if the data to be uploaded is registered, proceed to step 211.

Step 205: Select a CS in the domain where the ES is located (local domain) as an ACS and send a data uploading request.

Step 206: The ACS queries whether the data to be uploaded is partially stored. The ACS queries, according to the OID of the data to be uploaded, whether the data to be uploaded is registered (stored) by AN ICS. If a CS address corresponding to the OID is queried and found, it indicates that the data to be uploaded is registered (stored) and the CS address is returned, and proceed to step 207, or else the data to be uploaded is not registered (stored), and proceed to step 208.

Step 207: The ES continues transmission from a breakpoint to the corresponding CS according to the CS address.

Step 208: The ES uploads the data to the ACS.

Step 209: The CS (ACS) uploading and storing the data registers the OID of the data to be uploaded and the CS (ACS) address with the ICS. The ICS may notify the CS (ACS) of spreading the content to back up the content to an idle local CS.

Step 210: The ES sends a content registration request to the MM to register and store the OID of the data and cascade the NetID of a network (data center) that stores the data.

Step 211: The ES judges whether the data to be uploaded is stored locally. The ES compares whether its NetID1 is the same as the NetID2 in the response returned by the MM. If the two are the same, it indicates that the data to be uploaded is stored locally, and proceed to step 212; if the two are different, it indicates that the data to be uploaded is not stored locally, and proceed to step 213.

Step 212: Select a local CS locally as the ACS and request to query the ICS of the local network (local data center), where the query request carries the OID of the data.

Step 213: According to the NetID2 in the returned response, find a local GW bound with the NetID2 to request to query an ICS in a non-local network (non-local data center) (if no GW is bound with the NetID2, bind a GW in another network to forward the request), where the request carries the OID of the data.

Step 214: According to the OID of the data to be uploaded, the local ICS (non-local ICS) searches for a CS address that stores the data to be uploaded, and finally returns a search result of the CS address to the ES in the form of a list.

Step 215: Request offset block information from a CS that stores the data to be uploaded. A CS with the same NetID1 as the ES in the list is selected preferably. If there is no local CS, a CS in a non-local network (non-local data center) is selected from the list, where a network where the CS is located is bound with the GW of the network where the ES is located, and the binding weight of the GW to the ES is heavy.

Step 216: If the obtained offset block information is consistent with offset block information of the data submitted for uploading, return uploading success to the user, and proceed to step 210; otherwise, it indicates that the data to be uploaded is not consistent with the content stored in the network, and the uploading fails and ends.

In the embodiment of the present invention, whether the data is stored is judged according to the content ID of the data, so as to reduce the number of distribution of copies of the same content in the network in the system; when an upload network and a storage network are different, information interaction is performed through a bilateral or multilateral gateway, thus reducing a data traffic load between networks and increasing response efficiency, helping users in different networks obtain contents quickly, and enabling compatibility with other distributed storage systems.

### Embodiment 3

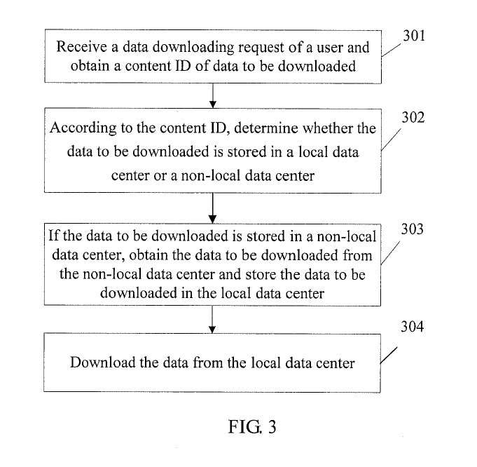

This embodiment provides a data downloading method. As shown in FIG. 3, the method includes:

Step 301: Receive a data downloading request of a user, and obtain a content ID of data to be downloaded.

This step may be executed by an edge server (ES) in a distributed data storage system. The downloading request received by the ES carries the content ID (OID) of the data to be downloaded, where the content is obtained through a Hash algorithm.

Step 302: According to the content ID, determine whether the data to be downloaded is stored in a local data center or a non-local data center.

This step may be executed by the ES and an MM of the distributed data storage system. The MM stores the content ID of the data and a NetID2 of a data center that stores the data. The ES submits a query request to the MM, and the MM queries the NetID2 of the data center which stores the data and corresponds to the content ID of the data, and returns the NetID2 to the ES through a query response. The ES compares the NetID2 of the data center that stores the data and a NetID1 of a data center where the ES is located. If the NetID1 and the NetID2 are consistent, the data is stored in the local data center (locally stored), or else the data is stored in a non-local data center (non-locally stored).

Step 303: If the data to be downloaded is stored in a non-local data center, obtain the data to be downloaded from the non-local data center and store the data in the local data center.

This step may be executed by the ES, a CS, and a GW of the distributed data storage system. The ES requests an index node (ICS) through a local access node (ACS) to query states of storage nodes, so as to obtain an address of an idle local CS, obtains the data from the non-local network through the GW and stores the data in the idle CS.

Step 304: Download the data from the local data center.

This step may be executed by the ES of the distributed data storage system. The ES downloads the data from the CS that stores the data.

In this embodiment, if the data is stored locally, the ES directly downloads the data locally. Specifically, the ES requests the ICS through the local ACS to query an address of the CS that stores the data; and downloads the data from the CS.

In the embodiment of the present invention, a network that stores the data is queried according to the content ID of the data, so as to realize uniform management and quick query of content copies in different networks, and reduce the number of distribution of copies of the same content in the network in the system; non-locally stored data is stored locally through a bilateral or multilateral gateway and then downloaded, thus reducing a data traffic load between different networks and increasing response efficiency, and helping users in different networks obtain contents quickly.

### Embodiment 4

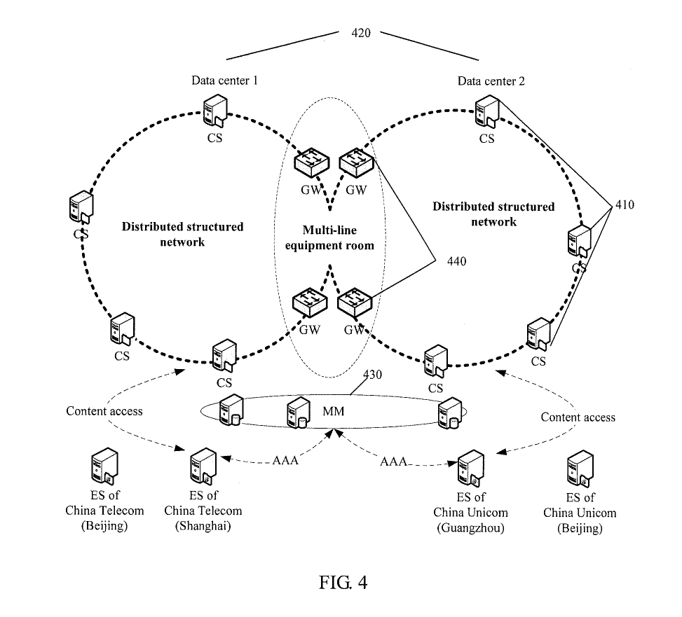

This embodiment provides a distributed data storage system. As shown in FIG. 4, the system includes:

an edge server (ES) 410, configured to: receive a data uploading or downloading request of a user and obtain a content ID; determine, according to a query result of a media manager (MM, Media Manager), whether to store the data and obtain information of a data center that stores the data; determine, according to the information of the data center, whether the data is stored in a local data center or a non-local data center and, if the data is stored in a non-local data center, request the non-local data center to check the data to be uploaded or downloaded;

multiple data centers 420, configured to query, according to the content ID, an address of a corresponding node that stores the data;

an MM 430, configured to query, according to the content ID of the data, the information of the data center that stores the data, and return the query result to the ES; and

a multilateral gateway (GW) 440, configured to exchange information between the multiple data centers.

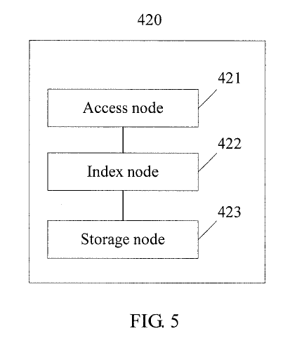

The data center 420 shown in FIG. 5 includes: an access node 421, configured to receive the uploading or downloading request forwarded by the ES; an index node 422, configured to query, according to the content ID of the data, the address of the node that stores the data; and a storage node 423, configured to store the data.

When the data is uploaded, the ES 410 receives the data uploading request, obtains a temporary OID of the data, and cascades a NetID1 of a domain where the ES is located. The ES 410 submits to the MM 430 a request to authenticate uploading legality of the user, and sends related information of the user and the OID and the NetID1 to the MM 430. The MM 430 authenticates, according to the related information of the user, whether the user has the upload right, and if the uploading is legal, the MM 430 further queries whether the data to be uploaded is registered, and returns an authentication and registration query result to the ES 410 through a response. The ES 410 receives the response returned by the MM 430. If the authentication result in the response is that the user is illegal, the uploading is ended. If the user is legal and the data to be uploaded is not registered, the complete data is uploaded in the domain where the ES is located (locally) or the uploading is continued from a breakpoint. After the uploading is complete, the ES 410 registers the OID of the data and the NetID1 of the domain where the ES is located with the MM. If the user is legal and the data to be uploaded is registered, the response carries a NetID2 of a corresponding data center where the data is registered. The ES 410 compares whether its NetID1 is the same as the NetID2 in the returned response. If they are the same, it indicates that the content is stored locally, and the ES 410 requests offset block information from the local data center. If they are different, the ES 410 requests offset block information from an inter-network data center through a GW 440 according to the NetID2 in the returned response (if no GW is bound with the NetID2, by binding a GW in another network). If the obtained offset block information is consistent with offset block information of the data submitted for uploading, the ES 410 returns uploading success to the user; and otherwise the uploading fails and is ended. After the uploading is successful, the ES 410 sends a content registration request to the MM 430 to register and store the OID of the data and cascade the NetID of the network (data center) that stores the data.

When the data is downloaded, the ES 410 submits a request to the MM 430 to query the NetID2 of the data center that stores the data. The ES 410 compares the received NetID2 of the data center that stores the data and a NetID1 of a data center where the ES 410 is located. If the NetID1 and the NetID2 are consistent, the data is stored locally, or else the data is stored non-locally. The ES 410 requests an ICS 422 through a local ACS 421 to query states of storage nodes, so as to obtain an address of an idle local CS, and requests the idle CS 423 to obtain the data non-locally through the GW 440 and store the data. The ES 410 downloads the data from the CS 423 that stores the data. If the data is locally stored, the ES 410 directly downloads the data locally. Specifically, the ES requests the ICS 422 through the local ACS 421 to query an address of the CS that stores the data; and downloads the data from the CS 423.

In the embodiment of the present invention, whether the data is stored or the network where the data is stored is determined according to the content ID of the data, thus realizing uniform management and quick query of content copies in different networks, and reducing the number of distribution of copies of the same content in the network in the system; when an upload network and a storage network are different, information is exchanged through a bilateral or multilateral gateway, and non-locally stored data is stored locally through the bilateral or multilateral gateway and then downloaded, thus reducing a data traffic load between different networks and increasing response efficiency; this helps users in different networks obtain contents quickly, and enables compatibility with other distributed storage systems.

Although the purposes, technical solutions, and benefits of the present invention are further described in detail through the foregoing specific embodiments, it should be understood that the foregoing description is merely specific embodiments of the present invention, and is not intended to limit the protection scope of the present invention. Any modification, equivalent replacement or improvement made to the present invention within the spirit and principle of the present invention shall fall within the protection scope of the present invention.

What is claimed is:

1. A data uploading method, comprising:
receiving a data uploading request of a user, and obtaining a content ID of data to be uploaded;
determining, according to the content ID, whether the data to be uploaded is already stored; and
if the data to be uploaded is not stored, uploading the data to be uploaded to a local data center and storing the data to be uploaded.

2. The method according to claim 1, further comprising:
if the data to be uploaded is already stored, obtaining information of a data center that stores the data to be uploaded; and
performing a consistency check on the center according to the information of the data center, wherein after the check is successful, it indicates that the uploading is successful.

3. The method according to claim 1, further comprising:
sending an uploading request to an access storage node of the local data center;
querying, by the access storage node, whether an address of a storage node corresponding to the content ID is registered with an index node of the local data center; and
if the address of the storage node is registered, continuing transmitting, to the storage node, the data to be uploaded from a breakpoint.

4. The method according to claim 3, further comprising:
if the address of the storage node is not registered, uploading the data to be uploaded to the access storage node.

5. The method according to claim 3, further comprising:
after the data to be uploaded is stored, registering, by a storage node that stores the data to be uploaded, the content ID of the data to be uploaded and the address of the storage node with the index node.

6. The method according to claim 1, further comprising:
authenticating whether the user is legal; and
if the user is legal, querying, according to the content ID, whether the data to be uploaded is already stored.

7. The method according to claim 2, wherein the step of performing the consistency check on the center according to the information of the data center comprises:
requesting offset block information from a corresponding data center according to the information of the data center; and
according to the offset block information, performing a consistency check between the stored data and the data to be uploaded.

8. The method according to claim 7, the step of requesting the offset block information from the corresponding data center according to the information of the data center comprises:
judging, according to the information of the data center, whether the corresponding data center is a local data center;
if the corresponding data center is a local data center, querying an index node of the local data center to obtain an address of a local storage node; and
requesting and obtaining the offset block information from the local storage node.

9. The method according to claim 8, further comprising:
if the corresponding data center is not a local data center, querying an index node of a data center corresponding to a gateway of a heaviest binding weight with the data center to obtain an address of a non-local storage node; and
requesting and obtaining the offset block information from the non-local storage node.

10. A data downloading method, comprising:
receiving a data downloading request of a user, and obtaining a content ID of data to be downloaded;
determining, according to the content ID, whether the data to be downloaded is stored in a local data center or a non-local data center;
if the data to be downloaded is stored in a non-local data center, obtaining the data to be downloaded from the non-local data center and storing the data to be downloaded in the local data center; and
downloading the data from the local data center.

11. The method according to claim 10, further comprising:
if the data to be downloaded is stored in the local data center, downloading the data from the local data center directly.

12. The method according to claim 10, wherein the step of determining, according to the content ID, whether the data to be downloaded is stored in a local data center or a non-local data center comprises:
querying, according to the content ID, an address of a data center that stores the data to be downloaded;
comparing the address of the data center and an address of the local data center;
if the address of the data center is different from the address of the local data center, determining that the data to be downloaded is stored in the non-local data center; and
if the address of the data center is the same as the address of the local data center, determining that the data to be downloaded is stored in the local data center.

13. The method according to claim 10, wherein the step of obtaining the data to be downloaded from the non-local data center and storing the data to be downloaded in the local data center comprises:
requesting an index node through a local access node to query states of storage nodes;
obtaining an address of an idle local storage node; and
obtaining the data from the non-local data center through a gateway and storing the data in the idle storage node.

14. A data system, comprising:
an edge server, configured to: receive a data uploading or downloading request of a user and obtain a content ID of data; determine, according to a query result of a media manager, whether to store the data and obtain information of a data center that stores the data; determine, according to the information of the data center, whether the data is stored in a local data center or a non-local data center and, if the data is stored in a non-local data center, request the non-local data center to check the data to be uploaded or downloaded;
multiple data centers, configured to query, according to the content ID, an address of a corresponding node that stores the data;
the media manager, configured to query, according to the content ID of the data, the information of the data center that stores the data, and return the query result to the edge server; and
a multilateral gateway, configured to exchange information between the multiple data centers.

15. The system according to claim 14, wherein the data center comprises:
an access node, configured to receive the uploading or downloading request forwarded by the edge server;
an index node, configured to query, according to the content ID of the data, an address of a node that stores the data; and
a storage node, configured to store the data.
